(19) United States
(12) Patent Application Publication
(10) Pub. No.: US 2017/0213261 A1
(43) Pub. Date: Jul. 27, 2017

(54) METHOD FOR DETECTING RIDERS AND MANAGING AND OPTIMIZING THEIR SHARED TRANSPORT

(71) Applicant: Stephane Jacques PERRET, URRUGNE (FR)

(72) Inventor: Stephane Jacques PERRET, URRUGNE (FR)

(21) Appl. No.: 15/412,473

(22) Filed: Jan. 23, 2017

(30) Foreign Application Priority Data
Jan. 22, 2016 (FR) 1650512

(51) Int. Cl. G06Q 30/02; G01S 19/24; G06Q 20/10; H04W 76/02; H04L 29/08; G01C 21/34; H04W 4/04

(52) U.S. Cl. CPC G06Q 30/0284; G01C 21/3438; G01S 19/24; H04W 4/046; H04W 76/02; H04L 67/12; G06Q 20/102; H04L 61/2007

(57) ABSTRACT

Disclosed is a method for detecting at least one rider with a smartphone in a vehicle that is driven by a driver with a smartphone (14C) for managing and optimizing their shared transport, with the vehicle being equipped with a short-range communication unit (10) corresponding to the size of the vehicle.

This invention relates to a method for detecting riders and managing and optimizing their shared transport.

The shared transport, also known under the name of ride-sharing, offers individuals, with no particular connection, the sharing of trips in the same vehicle.

It is known that a large number of vehicles are occupied by a single individual, the driver. This has the result of the number of vehicles growing almost in direct proportion to the growth of the population. This creates a negative energy balance since all of the energy consumed is dedicated to the transport of a single individual in a vehicle that can accommodate at least 1 rider, and even 4 riders, in addition to the driver, for most vehicles.

In addition, with the number of vehicles growing, the traffic's fluidity is decreasing, which creates loss of time on the one hand and overconsumption of energy on the other hand, with the pollution and carbon emission balances then also becoming more negative.

There are therefore drivers who travel on a given trip, with available seats, and riders who would be interested in said trip.

It is noted that there are two types of trips according to the distances, and the most common trips are the home/workplace commutes. These commutes are generally of short distance but regular both in destination and duration.

Solutions have been implemented for about ten years consisting in coordinating these riders, with no direct connection to the driver, wishing to share said given commute.

These solutions run through computer reservation sites over the Internet global connection network so as to match up the offers with the requests.

These sites require a voluntary approach and handle the financial transaction at the time of the reservation with a differentiated payment generally until the transaction is completed. The site that ensures the management of the transaction keeps a portion of this payment as a management fee.

In contrast, the riders who are likely to make use of shared transport services have, for the vast majority and even all of them, intelligent telephones—“smartphones”—connecting to the global communication network and to the Global Positioning System (GPS), making automatic locating possible.

In addition, these same smartphones are equipped with short-range radio communication means called “bluetooth,” in particular “low-energy bluetooth” BLE, a very low energy consumer, or else by “wifi.”

The object of this method, using a database and a server, is to detect—automatically—the presence of riders in a vehicle, to determine the distance and the presence time as well as the trip so as to initiate financial compensation, on the one hand, and to transmit at least proposals for ride-sharing between drivers and potential riders.

The method makes it possible to attribute financial compensation to the driver by the rider in such a way as to contribute to the fees associated with the trip, without having to reserve or to pay any sum in advance. In addition, the sum is perfectly suited to the length of the trip and/or the distance traveled since the two parameters are measured and recorded.

The method according to this invention also makes it possible to determine the regular commutes at regular hours and to offer ride-sharing to riders likely to make the same commute.

The method according to this invention is now described in detail according to a particular nonlimiting embodiment, in relation to the accompanying drawings, drawings in which the figures show:

FIG. 1: A view of the arrangement of the identification means and a server, and the entry of the driver into said vehicle,

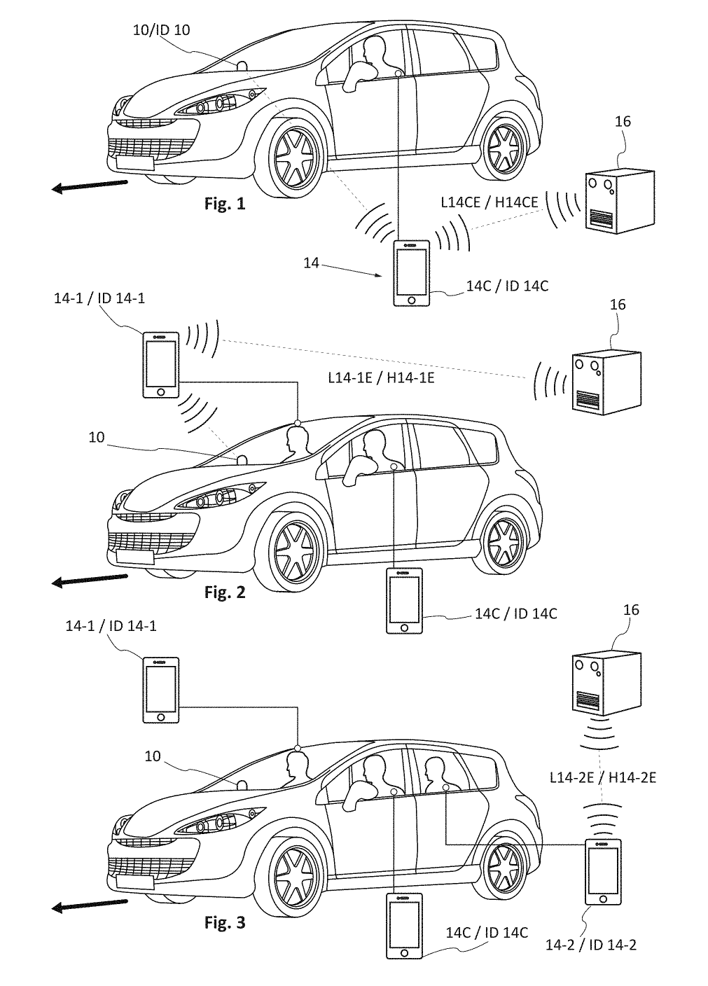

FIG. 2: A block diagram of the entry of a first rider into said vehicle,

FIG. 3: A block diagram of the entry of a second rider into said vehicle,

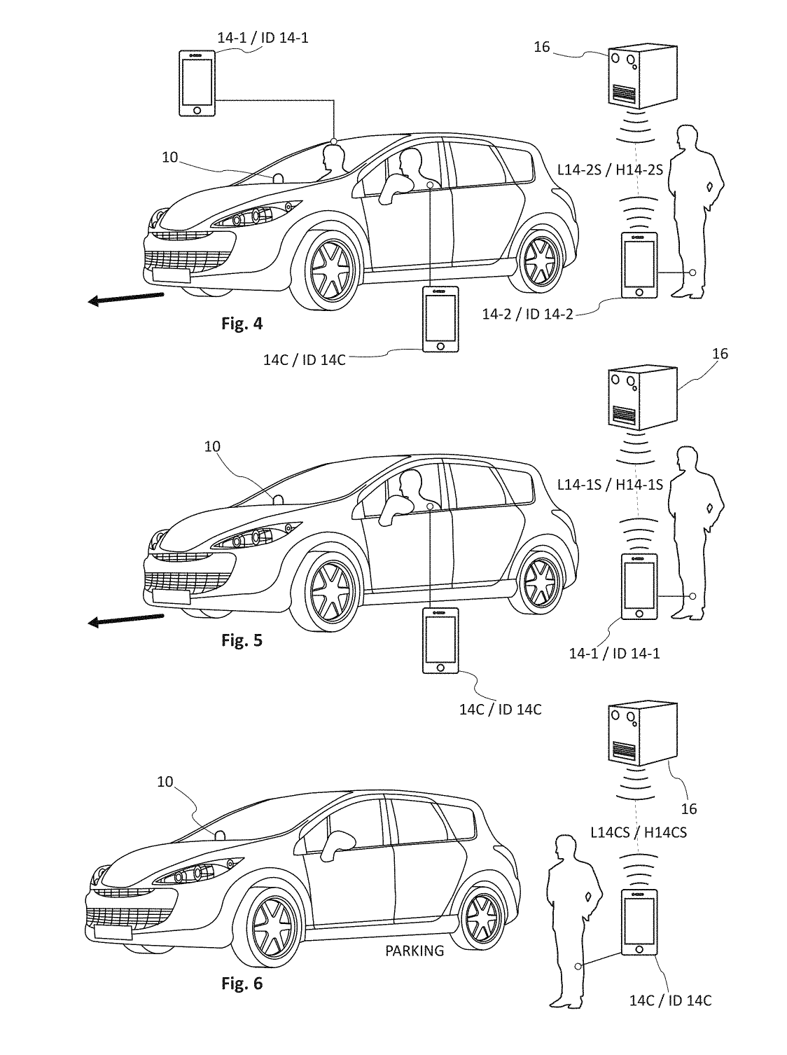

FIG. 4: A block diagram of the exit of the first rider from said vehicle,

FIG. 5: A block diagram of the exit of the second rider from said vehicle, and

FIG. 6: A block diagram of the exit of the driver from said vehicle.

The method according to this invention consists in using identification means 10 that can be scanned, in the form of a beacon, for example, in a vehicle 12, with an identifier ID10, as shown in FIG. 1.

These identification means 10 have particular functions, namely short-range radio transmission means that essentially cover the size, i.e., the volume, of the vehicle, of the type known as a “beacon.” Such identification means 10 can be detected during a scan, i.e., a sweeping of the frequencies by a smartphone, for example.

Such identification means 10 are advantageously supplied in an independent way because the electrical consumption remains very limited; in fact, they can be supplied by the electrical circuit of the vehicle. Likewise, not having any connection with the vehicle, they can be removable in such a way that the driver can move them in the event a different vehicle is used.

These identification means 10 are attached to the driver and cover a detection volume that is essentially equal to that of a vehicle. Thus, in a portable version, said identification means 10, of compact size, can be moved from the vehicle since they are attached to the driver. Such identification means 10 can even be integrated with a smartphone.

In a more developed version, the identification means can be connected to, and even integrated with, the combined system including a hands-free kit, GPS, and vehicle audio, while preserving the roaming function of said means.

Such identification means 10 are able to be detected by a smartphone 14 onto which a detection software application that also comprises a series of programmed actions has been downloaded. These identification means 10 can operate only in the corresponding volume, i.e., a limited space, provided that the short-range transmission means are activated.

The individuals dealing with the method according to the invention use a smartphone 14, onto which the detection software application has been downloaded, in such a way that said identification means 10 can be detected by and interact with said smartphone.

Said smartphone 14 uses, in a known way, a GPS locating application and a connection to the Internet global communication network.

A server 16, also connected to the Internet global communication network, can be joined by each smartphone 14 using its IP (Internet Protocol) address, and the server can join said smartphone so as to establish communication. This server 16 is a dedicated server and is associated with the downloaded software application.

In an embodiment of the method according to this invention, the driver uses a smartphone 14C, a first rider uses a smartphone 14-1, and a second rider uses a smartphone 14-2 as well. All of these phones are loaded with the software application.

Thus, when the driver enters into his vehicle, the identification means 10 detect his smartphone 14C with an identifier ID14C, which follows the steps of the procedure of the software application. The server 16 interacts with the smartphone 14C of the driver in such a way as to record the identifier ID10 of the identification means associated with the driver, the identifier ID14C of the smartphone 14C of the driver, the location L14CE during the entry into the vehicle, and the timestamp H14CE during the entry of said driver into the vehicle, see FIG. 1.

The driver moves with his vehicle and when a first rider enters into the vehicle, his smartphone 14-1 detects the identification means 10, and said smartphone 14-1, according to the instructions of the software application, interacts with the server 16 in such a way as to record the identifier ID10 of the identification means 10 associated with the driver, the identifier ID14-1 of the smartphone 14-1 of the first rider, the location L14-1E during the entry of the first rider into the vehicle, and the timestamp H14-1E during the entry of said first rider into the vehicle. See FIG. 2.

The vehicle moves, and a second rider enters into the vehicle while the first rider is still there. When this second rider enters into the vehicle, his smartphone 14-2 detects the identification means 10, and, according to the instructions of the software application, the smartphone 14-2 in its turn interacts with the server 16 in such a way as to record the identifier ID10 of the identification means 10 associated with the driver, the identifier ID14-2 of the smartphone 14-2 of the second rider, the location L14-2E during the entry of the second rider into the vehicle, and the timestamp H14-2E during the entry of said second rider into the vehicle. See FIG. 3.

The vehicle moves again, and when the second rider gets out of the vehicle, according to the example that is taken up, the smartphone 14-2 of this second rider no longer detects the identification means 10 associated with the driver.

Consequently, the method and therefore the associated software application again provide the connection by the smartphone 14-2 to the server 16 in such a way as to record the identifier ID10 of the identification means 10 associated with the driver, the identifier ID14-2 of the smartphone 14-2, the location L14-2S during the exit of the second rider from the vehicle, and the timestamp H14-2S during the exit of said second rider from the vehicle. See FIG. 4.

The server 16 then uses data on the departure and arrival from the trip making it possible to calculate the corresponding compensation C2, financial or otherwise, according to an established rule.

The compensation C2 is then allocated by any means suitable to the driver.

When the first rider in turn gets out, the smartphone 14-1 of the first rider is no longer in connection with the identification means 10 associated with the driver.

Consequently, the method and therefore the associated software application again provide the connection by the smartphone 14-1 to the server 16 in such a way as to record the identifier ID10 of the identification means 10 associated with the driver, the identifier ID14-1 of the smartphone 14-1 of the first rider, the location L14-1S during the exit of the first rider from the vehicle, and the timestamp H14-1S during the exit of said first rider from the vehicle. See FIG. 5.

The server 16 then uses data of the departure and the arrival from the trip making it possible to calculate the corresponding compensation C1, according to the same established scale that can be applied to all riders using the software application.

The financial compensation C1 is then allocated by any means suitable to the driver.

The method according to this invention thus makes possible a calculation of the actual distance.

It is furthermore possible to record intermediate points in such a way as to get as close as possible to the trip that is made, in particular when a detour, a bypass, or a round-trip close to a loop is called for.

This recording of the points can be done according to a time base, with intervals of x minutes, or on a voluntary basis upon intervention of the driver by manual or vocal action.

When the server 16 has recorded the allocation of the compensation C1, it then makes it possible for the rider who has the smartphone 14-1 to enter another vehicle and to complete another ride-sharing session.

The compensation means can be allocated instantaneously upon exiting from the vehicle because the rider with the smartphone 14-1 only has to validate a request for compensation of a value C1 from the server 16. This compensation can be financial in the form of a “withdrawal” via an electronic wallet, for example, or in the form of an allocation to a kilometric account.

The same is true for the payment of the compensation C2 by the rider with the telephone 14-2.

In the case where the compensation is not made by the exiting rider, use of the method in question from the smartphone for which the debt is owed is prohibited.

Relative to the driver, with the identifier ID14C associated with the identification means 10, the server 16 records the location L14CE of entry of the driver into the vehicle and the timestamp H14CE as well as the location L14CS and the timestamp H14CS during the exit of the driver from the vehicle. See FIG. 6.

Actually, no compensation is initiated, but the server 16 uses data of the departure and arrival from the trip from a smartphone.

These data can make it possible to generate when said trip reproduces a trip type TT, in particular a home/workplace commute, primarily when this commute is associated with an hourly range that is also repetitive.

It is then advisable to define an hourly range around an average that is calculated in relation to the timestamps that are recorded and to provide a surrounding distance in relation to the endpoints recorded to take into account approximations linked to the selected parking location of the vehicle for example, with the variations of the departure schedule.

Consequently, the trip type TT is identified when the frequency n is at a minimum equal to a given value, for example 5. It is also possible to set other parameters such as a frequency n for the same day and/or a frequency over several consecutive days. It is then possible to compare the trip type TT with the trip carried out by other drivers or riders, in the same hourly range. The server 16 holds an item of information according to which a driver or a rider completes the same trip TT.

A message can then inform the different smartphones of the situation. The method then provides that each of the owners of the smartphones in question can make contact or not to organize ride-sharing.

As soon as the trip type no longer complies with the recorded criteria, the trip type TT is eliminated from the offers.

The drivers and/or riders with smartphones on which the software application is loaded can thus search in a known way on the database of the server 16 according to any criterion, but the drivers and/or riders can interact, in addition, for ride-sharing, more particularly regular ride-sharing.

The frequency n of a trip type TT carried out by a driver in a given hourly range is thus established; the frequency m of a trip carried out by at least one rider in the same hourly range and based on a frequency threshold n is established; said at least one rider is informed that said driver is completing said trip within said hourly range.

The driver can also be a rider, and the rider can also be a driver.

These proposals can evolve over time and as soon as a trip is no longer carried out regularly, the software application may assume that the trip has become non-regular and the trip is no longer proposed.

In an improved way, the method also provides for interacting with a driver or rider user if he/she completes only a portion of the trip TT carried out by another rider/driver.

The method also provides for the detection of any break in the location function of the smartphone if the rider with his/her smartphone deactivates the location function, for example, or the BLE function. Such a break in connection would lead to errors in calculating the financial compensation. This also prevents any fraud.

In a complementary way, the riders of the same vehicle and the driver can be informed of each action, for example the entry or exit of a rider.

1. Method for detecting at least one rider with a smartphone (14-1, 14-2) in a vehicle driven by a driver with a smartphone (14C) for managing and optimizing their shared trips, a server (16), connected to the Internet global communication network, which can be joined by each of the smartphones (14) using its IP address, with said server (16) being able to join each of said smartphones (14) so as to establish communication, the method comprising the following steps:
Association with the driver of the vehicle of an identifier ID10 of short-range identification means (10) that cover essentially the size, i.e., the volume, of said vehicle,
Detection of this identifier ID10 of the identification means (10) by a smartphone 14C associated with the driver with an identifier ID14C,
Recording of the identifier ID10 of the identification means (10) associated with the driver, the identifier ID14C of the smartphone 14C of the driver, the location L14CE of the entry into the vehicle, and the timestamp H14CE of the entry of said driver into the vehicle,
Recording, during the entry of a rider into said vehicle, of the identifier ID10 of the identification means (10) associated with the driver, of the identifier ID14-1 of the smartphone 14-1 of this rider, of the location L14-1E during the entry of the first rider into the vehicle, and of the timestamp H14-1E of the entry of said rider into the vehicle,
Movement of the vehicle,
Recording, during the exit of said rider from said vehicle, of the identifier ID10 of the identification means (10) associated with the driver, of the identifier ID14-1 of the smartphone 14-1, of the location L14-1S of the exit of the rider from the vehicle, and of the timestamp H14-1S of the exit of said rider from the vehicle,
Calculation of the trips made by the driver and by said rider.

2. Method for detecting at least one rider with a smartphone (14-1, 14-2) in a vehicle driven by a driver with a smartphone (14C) according to claim 1, further comprising a step for calculating the compensation C owed by the rider to the driver, starting from the trip carried out by the rider.

3. Method for detecting at least one rider with a smartphone (14-1, 14-2) in a vehicle driven by a driver with a smartphone (14C) according to claim 1, further comprising a step for establishing the frequency n of a trip type TT carried out by a driver in a given hourly range; the frequency m of a trip carried out by at least one rider is established in the same hourly range and based on a frequency threshold n; said at least one rider is informed that said driver is completing said trip in said hourly range.

4. Method for detecting at least one rider with a smartphone (14-1, 14-2) in a vehicle driven by a driver with a smartphone (14C), according to claim 3, wherein to establish a trip type TT, it comprises a step for analysis of the frequency n for the same day and/or the frequency over several consecutive days.

5. Method for detecting at least one rider with a smartphone (14-1, 14-2) in a vehicle driven by a driver with a smartphone (14C), according to claim 2, further comprising a step for defining an hourly range over an average calculated in relation to the recorded timestamps and to a surrounding distance in relation to the endpoints recorded.

6. Method for detecting at least one rider with a smartphone (14-1, 14-2) in a vehicle driven by a driver with a smartphone (14C) according to claim 2, further comprising a step for establishing the frequency n of a trip type TT carried out by a driver in a given hourly range; the frequency m of a trip carried out by at least one rider is established in the same hourly range and based on a frequency threshold n; said at least one rider is informed that said driver is completing said trip in said hourly range.

7. Method for detecting at least one rider with a smartphone (14-1, 14-2) in a vehicle driven by a driver with a smartphone (14C), according to claim 3, further comprising a step for defining an hourly range over an average calculated in relation to the recorded timestamps and to a surrounding distance in relation to the endpoints recorded.

8. Method for detecting at least one rider with a smartphone (14-1, 14-2) in a vehicle driven by a driver with a smartphone (14C), according to claim 4, further comprising a step for defining an hourly range over an average calculated in relation to the recorded timestamps and to a surrounding distance in relation to the endpoints recorded.

9. Method for detecting at least one rider with a smartphone (14-1, 14-2) in a vehicle driven by a driver with a smartphone (14C), according to claim 7, further comprising a step for defining an hourly range over an average calculated in relation to the recorded timestamps and to a surrounding distance in relation to the endpoints recorded.
